(19) United States
(12) Patent Application Publication
(10) Pub. No.: US 2005/0221860 A1
(43) Pub. Date: Oct. 6, 2005

(54) Electronic device

(75) Inventor: Masato Yamaji, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/097,406

(22) Filed: Mar. 31, 2005

(30) Foreign Application Priority Data
Apr. 5, 2004 (JP) 2004-111020

(51) Int. Cl. H04M 3/42

(52) U.S. Cl. 455/557

(57) ABSTRACT

An electronic device includes a communication unit which performs transmission/reception of data through a wireless network, and an application processing unit which executes an application processing. While the application processing is not required, the application processing unit is in a sleep state or a stand-by state.

### CROSS-REFERENCE TO RELATED APPLICATIONS

This application is based upon and claims the benefit of priority from the prior Japanese Patent Applications No. 2004-111020, filed on Apr. 5, 2004, the entire contents of which are incorporated herein by reference.

### BACKGROUND OF THE INVENTION

1. Field of the Invention

This invention relates to an electronic device for performing communication with the outside through a wireless network, and especially an electronic device capable of reducing power consumption.

2. Description of the Related Art

The following documents are referred to as related art of an electronic device for performing communication with the outside through a wireless network.

JP-A-08-084111 and JP-A-2002-050998 are referred to as the related art.

FIG. 3 is a block diagram showing an example of such an electronic device for performing communication with the outside through a wireless network. In FIG. 3, the electronic device has a peripheral device 1 such as an external memory or a sensor; an operation control unit 2 such as CPU (Central Processing Unit); a wireless communication unit 3 for performing communication with the outside through a wireless network; and a power source 4 for supplying electric power to the peripheral device 1, the operation control unit 2 and the wireless communication unit 3.

The peripheral device 1 is connected to the operation control unit 2. The operation control unit 2 is connected to the communication unit 3. The power source 4 is connected to the peripheral device 1, operation control unit 2 and wireless communication unit 3, respectively. The wireless communication unit 3 is connected to a wireless network (not shown).

Now, an explanation will be given of the operation of the electronic device shown in FIG. 3. The peripheral device 1, for example, if it is a sensor, outputs a measured physical amount such as temperature to the operation control unit 2. The operation control unit 2 subjects a received output to necessary operation processing as required and thereafter controls the wireless communication unit 3 to transmit the result of processing to the outside via a wireless network (not shown).

On the other hand, where the wireless communication unit 3 has received a request of e.g. temperature information from an external device through a wireless network (not shown), the operation control unit 2 analyzes the received request on the basis of notification from the wireless communication unit 3 to take the steps corresponding to the request (transmission of e.g. temperature information).

Thus, the operation control unit 2 controls the wireless communication unit 3 to transmit or receive information via the wireless network (not shown).

However, in the electronic device as shown in FIG. 3, the operation control unit 2 executes the application of the electronic device at issue and also performs control of the wireless communication unit 3 or data transmission/reception on the way thereof. This requires that the operation control unit 2 has some processing capability, thus giving a problem of increasing power consumption.

In addition, since it is unknown when wireless communication is received, the wireless communication unit 3 must be always controlled. This leads to a problem that it is difficult to reduce the power consumption by always operating the operation control unit 2 accompanied with large power consumption as described above.

### SUMMARY OF THE INVENTION

An object of the invention is to provide an electronic device capable of reducing power consumption.

The invention provides an electronic device, having: a communication unit which performs transmission/reception of data through a wireless network; and an application processing unit which executes an application processing, wherein while the application processing is not required, the application processing unit is in a sleep state or a stand-by state.

In the electronic device, the communication unit includes: a wireless communication unit; a first operation control unit which controls the wireless communication unit and transfers information to and from the application processing unit; and a first power source which supplies electric power to the wireless communication unit and the first operation control unit.

In the electronic device, the application processing unit includes: a peripheral device; a second operation control unit which controls the peripheral device, transfers information to and from the communication unit, and is in a sleep state or a stand-by state while the application processing is not required; and a second power source which supplies electric power to the peripheral device and the second operation control unit.

The invention also provides an electronic device, having: a communication unit which performs transmission/reception of data through a wireless network; and an application processing unit which executes an application processing, wherein while the application processing is not required, the communication unit interrupts electric power to be supplied to the application processing unit.

In the electronic device, the application processing unit includes: a peripheral device; a second operation control unit which controls the peripheral device, and transfers information to and from the communication unit; a second power source which supplies electric power to the peripheral device and the second operation control; and a switching unit which controls supply of the electric power from the second power source to the second operation control unit.

In the electronic device, the communication unit includes: a wireless communication unit; a first operation control unit which controls the wireless communication unit, transfers information to and from the application processing unit, and controls the switching unit to interrupt the electric power to be supplied to the application processing unit while the application processing is not required; and a first power source which supplies electric power to the wireless communication unit and the first operation control unit.

In the electronic device, the wireless communication unit executes filtering of information unnecessary for the application processing to be executed by the application processing unit.

In the electronic device, the first power source is a solar cell.

In the electronic device, the first power source is a power source with limited capacity which is directly supplied from a connected network.

The electronic device is separated into the communication unit and the application processing unit provided with dedicated operation control unit and dedicated power source, respectively. While the application processing is not required, the application processing unit is in a sleep state or stand-by state, or otherwise the communication unit interrupts the supply of electric power to be supplied to the application processing unit, thereby suppressing power consumption. In addition, the first operation control unit in the communication unit is constructed of a powerless CPU with low power consumption. Accordingly, the electronic device permits power consumption to be reduced.

### BRIEF DESCRIPTION OF THE DRAWINGS

FIG. 1 is a block diagram showing a first embodiment of an electronic device according to the invention;

FIG. 2 is a block diagram showing a second embodiment of an electronic device according to the invention; and

FIG. 3 is a block diagram showing an example of a related electronic device for performing communication with the outside through a wireless network.

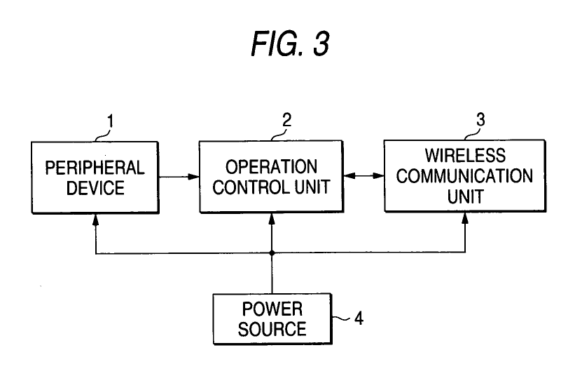

### DETAILED DESCRIPTION OF THE PREFERRED EMBODIMENTS

Now referring to the drawings, embodiments of an electronic device according to the invention will be given in detail.

### First Embodiment

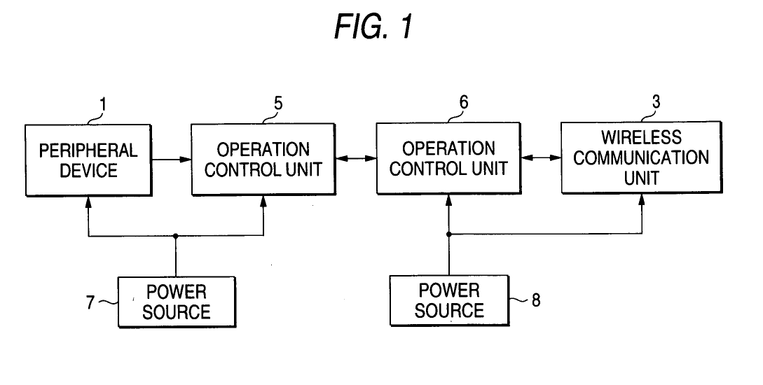

FIG. 1 is a block diagram showing a first embodiment of an electronic device according to the invention. In FIG. 1, the electronic device of the embodiment has a peripheral device 1 such as an external memory or a sensor; an operation control unit 5 such as CPU for executing an application; a wireless communication unit 3 for performing communication with the outside through a wireless network; an operation control unit 6 such as CPU for executing the control of the wireless communication unit 3 and the transmission/reception of data; a power source 7 for supplying electric power to the peripheral device 1 and the operation control unit 5; and a power source 8 for supplying electric power to the operation control unit 6, and the wireless communication unit 3.

In the embodiment, the peripheral device 1, the operation control unit 5 and the power source 7 constitute an application processing unit, and the wireless communication unit 3, operation control unit 6 and the power source 8 constitute a communication unit.

The peripheral device 1 is connected to the operation control unit 5. The operation control unit 5 is connected to the operation control unit 6. The operation control unit 6 is connected to the communication unit 3.

Further, the power source 7 is connected to the peripheral device 1 and operation control unit 5, respectively. The power source 8 is connected to the operation control unit 6 and wireless communication unit 3, respectively. The wireless communication unit 3 is connected to a wireless network (not shown).

Now, an explanation will be given of the operation of the embodiment of the electronic device shown in FIG. 1. The wireless communication unit 3 performs transmits/receives data through a wireless network to perform communication with an external device and so on. The operation control unit 6 saves wireless-associated setting information and controls the wireless communication unit 3. Especially, the operation control unit 6 transfers acquired information and processing result in the operation control unit 5 between itself and the operation control unit 5 to and from the operation control unit 5. It should be noted that the operation control unit 6 executes no application-associated processing.

Therefore, the operation control unit 6, even if it is a powerless CPU with low power consumption, can be sufficiently put to practical use.

The peripheral device 1, for example, if it is a sensor, outputs data obtained by measuring a physical amount such as temperature to the operation control unit 5. The operation control unit 5 processes data received from the peripheral device 1 and thereafter transmits the result of the processing to the operation control unit 6.

Further, the operation control unit 5 is placed in a sleep state or a stand-by state while the application processing is not required thereby to suppress power consumption.

As explained above, the electronic device is separated into the communication unit including the wireless communication unit 3, operation control unit 6 and the power source 8, and the application processing unit including the peripheral device 1, the operation control unit 5 and the power source 7. Especially, the dedicated operation control unit and the dedicated power source are provided in the communication unit and the application processing unit, respectively. While the application processing is not required, the operation control unit 5 in the application processing unit is placed in a sleep state or stand-by state, thereby suppressing power consumption. In addition, if the operation control unit 6 in the communication unit is constructed of a powerless CPU with low power consumption, power consumption is further reduced.

### Second Embodiment

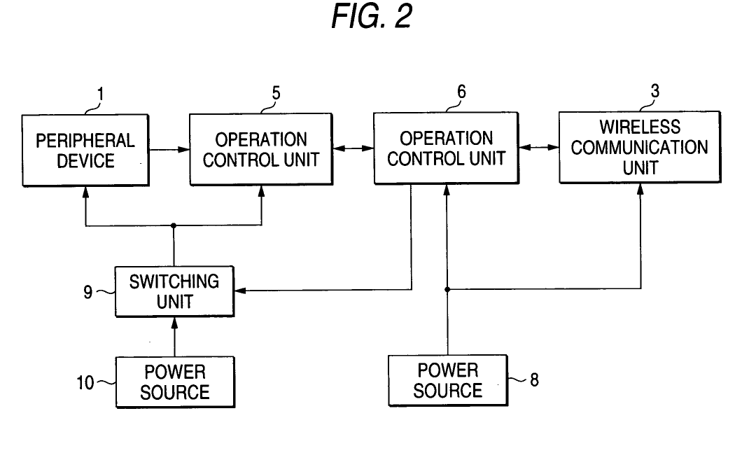

FIG. 2 is a block diagram showing a second embodiment of an electronic device according to the invention. In FIG. 2, the electronic device of the embodiment has the peripheral device 1; the operation control unit 5; a power source 10 for supplying electric power to the peripheral device 1 and the operation control unit 5; a switching unit 9 such as a switch or relay for controlling supply of the electric power from the power source 10; the operation control unit 6; the wireless communication unit 3; and the power source 8. Since the peripheral device 1, the wireless communication unit 3, the operation control unit 5, the operation control unit 6, and the power source 8 are same with those shown in FIG. 1, explanation regarding those are not given in the embodiment.

In the embodiment, the peripheral device 1, the operation control unit 5, the switching unit 9 and the power source 10 constitute an application processing unit, and the wireless communication unit 3, operation control unit 6 and the power source 8 constitute a communication unit.

The peripheral device 1 is connected to the operation control unit 5. The operation control unit 5 is connected to the operation control unit 6. The operation control unit 6 is connected to the wireless communication unit 3. The operation control unit 6 is connected to the switching unit 9.

Further, the power source 10 is connected to the switching unit 9. The switching unit 9 is connected to the peripheral device 1 and operation control unit 5, respectively. The power source 8 is connected to the operation control unit 6 and wireless communication unit 3, respectively. The wireless communication unit 3 is connected to a wireless network (not shown).

Now, an explanation will be given of the operation of the embodiment of the electronic device shown in FIG. 2. The wireless communication unit 3 performs transmits/receives data through a wireless network to perform communication with an external device and so on. The operation control unit 6 saves wireless-associated setting information and controls the wireless communication unit 3. Especially, the operation control unit 6 transfers acquired information and processing result in the operation control unit 5 between itself and the operation control unit 5 to and from the operation control unit 5. It should be noted that the operation control unit 6 executes no application-associated processing.

Further, the operation control unit 6, if it determines that the application processing is required according to the condition of wireless communication, controls the switching unit 9 to supply the electric power from the power source 10 to the operation control unit 5 and others.

Further, the operation control unit 6, if it determines that the application processing is not required according to the condition of wireless communication, controls the switching unit 9 to interrupt the supply of the electric power from the power source 10 to the operation control unit 5 and others.

As explained above, the electronic device is separated into the communication unit including the wireless communication unit 3, operation control unit 6 and the power source 8, and the application processing unit including the peripheral device 1, the operation control unit 5, the switching unit 9 and the power source 10. Especially, the dedicated operation control unit and the dedicated power source are provided in the communication unit and the application processing unit, respectively. While the application processing is not required, the operation control unit 6 interrupts the supply of the electric power to the operation control unit 5 and others, thereby suppressing power consumption.

In the first embodiment shown in FIG. 1, if the operation control unit 6 is constructed of a powerless CPU with low power consumption, the power source 8 may be a power source with limited capacity which is directly supplied from a connected network such as a solar cell or a bus power from a USB (Universal Serial Bus).

Further, in the first embodiment shown in FIG. 1, it was explained that the operation control unit 5 is placed in a sleep state or a stand-by state while the application processing is not required, thereby suppressing power consumption. But the peripheral device 1 may also be placed in the sleep state or the stand-by state, thereby further suppressing power consumption.

In the first embodiment shown in FIG. 1, the operation control unit 6 may execute filtering of the information unnecessary for the application processing to be executed by the operation control unit 5.

In this case, it is not necessary to activate the operation control unit 5 so that it receives unnecessary information, thereby suppressing power consumption.

1. An electronic device, comprising:
a communication unit which performs transmission/reception of data through a wireless network; and
an application processing unit which executes an application processing,
wherein while the application processing is not required, the application processing unit is in a sleep state or a stand-by state.

2. The electronic device according to claim 1,
wherein the communication unit includes:
a wireless communication unit;
a first operation control unit which controls the wireless communication unit and transfers information to and from the application processing unit; and
a first power source which supplies electric power to the wireless communication unit and the first operation control unit.

3. The electronic device according to claim 1,
wherein the application processing unit includes:
a peripheral device;
a second operation control unit which controls the peripheral device, transfers information to and from the communication unit, and is in a sleep state or a stand-by state while the application processing is not required; and
a second power source which supplies electric power to the peripheral device and the second operation control unit.

4. An electronic device, comprising:
a communication unit which performs transmission/reception of data through a wireless network; and
an application processing unit which executes an application processing,
wherein while the application processing is not required, the communication unit interrupts electric power to be supplied to the application processing unit.

5. The electronic device according to claim 4,
wherein the application processing unit includes:
a peripheral device;
a second operation control unit which controls the peripheral device, and transfers information to and from the communication unit;
a second power source which supplies electric power to the peripheral device and the second operation control; and
a switching unit which controls supply of the electric power from the second power source to the second operation control unit.

6. The electronic device according to claim 5,
wherein the communication unit includes:
a wireless communication unit;
a first operation control unit which controls the wireless communication unit, transfers information to and from the application processing unit, and controls the switching unit to interrupt the electric power to be supplied to the application processing unit while the application processing is not required; and
a first power source which supplies electric power to the wireless communication unit and the first operation control unit.

7. The electronic device according to claim 1,
wherein the wireless communication unit executes filtering of information unnecessary for the application processing to be executed by the application processing unit.

8. The electric device according to claim 2,
wherein the first power source is a solar cell.

9. The electronic device according to claim 2,
wherein the first power source is a power source with limited capacity which is directly supplied from a connected network.

10. The electronic device according to claim 4,
wherein the wireless communication unit executes filtering of information unnecessary for the application processing to be executed by the application processing unit.

11. The electric device according to claim 6,
wherein the first power source is a solar cell.

12. The electronic device according to claim 6,
wherein the first power source is a power source with limited capacity which is directly supplied from a connected network.
